(19) United States
(12) Patent Application Publication
(10) Pub. No.: US 2014/0007618 A1
(43) Pub. Date: Jan. 9, 2014

(54) Integrated Handcuff Key Bracelet

(71) Applicant: Charles Brown, III, Carrollton, TX (US)

(72) Inventor: Charles Brown, III, Carrollton, TX (US)

(73) Assignee: Charles H. Brown, III, Carrollton, TX (US)

(21) Appl. No.: 13/541,920

(22) Filed: Jul. 5, 2012

(51) Int. Cl. A44C 13/00; E05B 19/02

(52) U.S. Cl. 63/1.18

(57) ABSTRACT

A wearable jewelry item having a flexible body with a key end and a receiving end; a closure mechanism affixed to the key end and receiving end of the flexible body, the closure mechanism having a first part and a second part that interlock; a key blade affixed to either the first part or the second part of the closure mechanism, the key blade including a flat, rectangular bit adapted to release a handcuff lock; and a receiving space integral with the part of the closure mechanism that is free of the key blade.

### FIELD OF THE INVENTION

This invention is generally related to restraining devices used by law enforcement personnel and is specifically directed to an integrated handcuff key-jewelry item for use with a lockable restraining device such as handcuffs.

### BACKGROUND

One of the most common and reusable restraining devices used by modern law enforcement are steel handcuffs. The handcuffs operate and are adjustable based on a common level ratcheting mechanism. Handcuffs are most commonly released by the use of a handcuff key.

Prior art handcuff keys, such as the key shown in FIG. 1C, are provided with a blade 1 having an unlocking bit 2 mounted flush with one end of the blade 1, a bow 3, and a double-lock engaging stem extending from the end of the key opposite the end bearing the unlocking bit. The key may be cylindrical, having a bow disposed about the cylinder of the key, or symmetrical, having a bow in substantially the same plane as the bit. A key ring can also be provided to permit attachment of the key to the belt of a law enforcement officer.

In any case, the bit-bearing end of the blade is intended to mate with a socket in a standard, ratchet and pawl metallic handcuff. Specifically, the key is inserted into the keyhole of a handcuff. The keyhole shape is defined by an annular aperture intersecting with a rectangular notch. This shape corresponds to the cross-sectional shape of the bit-bearing end of the blade such that the key can be inserted into the handcuff when the notch of the keyhole is aligned with the bit of the key. Once inserted into a handcuff, the key is turned to disengage the teeth of the ratchet with the teeth of the pawl.

Handcuffs and handcuff keys are typically utilized in environments that often make it difficult to engage and disengage the locking mechanism of the handcuffs. Specifically, arresting officers may be faced, among other things, with poor lighting, struggling suspects, and/or wet conditions such as those which may foster mud or other debris which could interfere with insertion of a key in a keyhole. In any event, conditions such as these can often hinder use of the prior art handcuff key.

Under any condition, a handcuff key should be readily accessible and useable without undue loss of time during retrieval. Most keys are carried either in a pocket or attached to an officer's uniform. If a key is carried in a pocket of the officer's uniform, the correct pocket must be ascertained, and then the officer must retrieve the key, tying up one hand in the process. Although a key attached to the outside of an officer's uniform may be more easily accessible, the key must be detached from the uniform. In some cases, an attachment link is pivotally mounted on the key adjacent either the engagement stem or the unlocking bit so that the link extends over the end of the key. This link permits the key to be secured to a chain, key ring, or similar device, and to swing freely therefrom. However, because the link is generally attached to pivot adjacent either the stern or the paddle, it can interfere with use of that mechanism during locking and unlocking. Therefore, the link must be secured in a non-interfering position. in either example, retrieval and use of such a key requires time and attention. In instances where a plurality of keys are attached to a single key ring, this problem is exacerbated.

### SUMMARY

The herein presented invention provides a jewelry item integrated handcuff key that can be worn by a user without being intermixed with other keys or inaccessible in a large pocket. Various features of the jewelry item allow for the easy access and use of the handcuff key. In various embodiments, the handcuff key is accessible (i.e., can extend from a closure mechanism) and usable (i.e., can be employed to unlock a handcuff) without disengagement from an open closure mechanism. For example, the bit and blade of the handcuff key can extend beyond the open closure mechanism. In other embodiments, the handcuff key is integrated into the body of a flexible bracelet or necklace and, optionally, does not form part of a closure mechanism.

### DESCRIPTION OF THE DRAWINGS

For a more complete understanding of the disclosure, reference should be made to the following detailed description and accompanying drawing figures wherein:

FIG. 1A is a representation of a closure mechanism having an integrated handcuff key, FIG. 1B is an end-on view of one half of the closure mechanism, and FIG. 1C is a representation of a handcuff key known in the art;

FIG. 2A is a representation of a second closure mechanism having an integrated handcuff key, FIG. 2B is an end-on view of one half of this second closure mechanism;

FIG. 3A is a representation of one half (key end) of a third closure mechanism having an integrated handcuff key, FIG. 3B is a representation of the other half of the third closure mechanism (receiving end);

FIG. 4A is a representation of one half (receiving end) of a fourth closure mechanism haying an integrated handcuff key, FIG. 4B is a representation of the other half of the third closure mechanism (key end) haying an integrated handcuff key;

FIG. 5 is representation of a clasp mechanism adapted to hold a handcuff key, where FIG. 5A shows the clasp mechanism and FIGS. 5B and 5C should the clasp mechanism carrying a handcuff key; and

FIG. 6 is a representation of a second clasp mechanism adapted to hold a handcuff key (not shown) within an elastic body.

While specific embodiments are illustrated in the figures, with the understanding that the disclosure is intended to be illustrative, these embodiments are not intended to limit the invention described and illustrated herein.

### DETAILED DESCRIPTION

Described herein is a jewelry item (e.g., a bracelet or a necklace) that provides a wearer the ability to directly and securely carry a key (e.g., a handcuff key) upon their person. The terminology for keys varies somewhat, the following terms are used throughout the present description: key bow; key shoulder, key blade, bit. As used herein a key bow is a gripping portion of the key, optionally called a key head. The key bow does not enter a locking mechanism but provides a surface against which a torque can be provided to lock or unlock a mechanism. A key shoulder is a structure positioned between the key bow and the key blade that often controls the depth that a key blade can enter a locking mechanism. Herein, the key shoulder often does not control the depth that a key blade can enter a locking mechanism. The key shoulder is typically larger, in at least one dimension, than the key blade (e.g., the height of the key shoulder can be larger than the height of the key blade; preferably, the key shoulder is shorter than the key blade). A key blade is the portion of a key that enters or engages with a locking mechanism. For handcuff keys, the key blade, typically, has a cylindrical body and a bit extending from the terminal end of the cylindrical body. The cylindrical body of a handcuff key blade can be hollow or partially hollow.

In examples or embodiments that include a handcuff key or key blade, the handcuff key or key blade can include (be made of) a composite material, a thermoset polymer, a metal, or a metal alloy. Examples of a composite material include Kevlar composites, carbon fiber composites, and fiberglass composites. Examples of a thermoset polymer include polystyrenes, polyethylenes, polyurethanes, and polyacrylates. Preferable handcuff keys or key blades are made from metals or metal alloys, for example, aluminum and stainless steel.

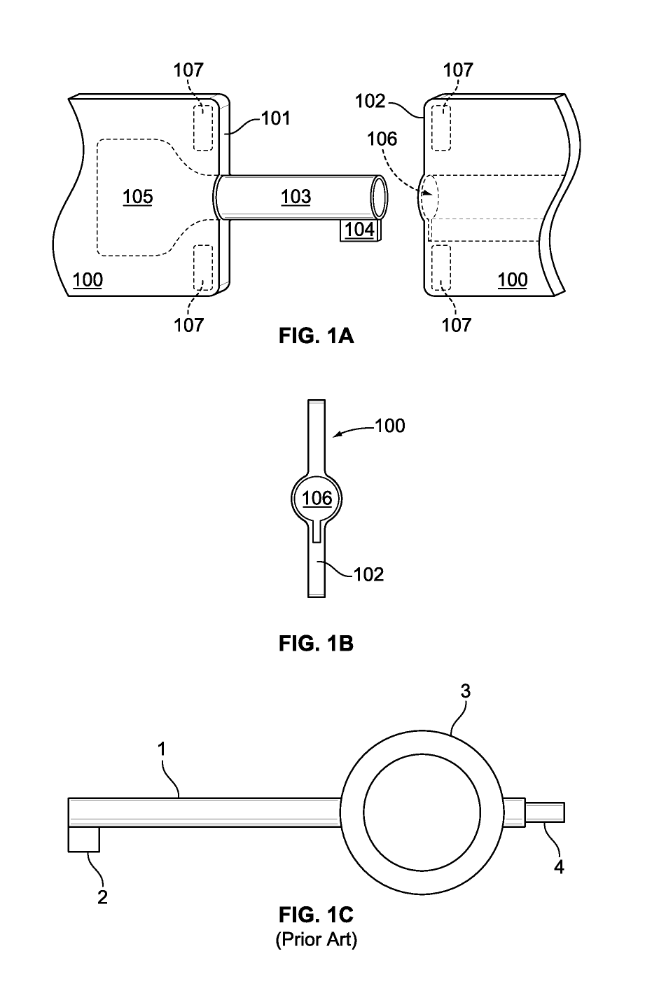

With reference to FIGS. 1A and 1B: a first embodiment is a bracelet that includes a flexible bracelet body 100 having a key end 101 and a receiving end 102; a key blade 103 extending from the key end 101 of the flexible bracelet body 100, the key blade 103 including a flat, rectangular bit 104 adapted to release a handcuff lock: and a key hole 106 integral with the receiving end 102 of the flexible bracelet body 100. The key hole 106 is adapted to receive the key blade 103 and bit 104. For example, the key hole 106 can be defined by an annular aperture intersected with a rectangular notch. This embodiment can further include a key bow 105 that is fixedly connected to the key end 101 of the flexible bracelet body 100, Preferably, the key bow 105 is imbedded within the flexible bracelet body 100, Alternatively, the key bow 105 can be attach to the flexible bracelet body 100 by a snap, or toothed connector. The key bow 105 is fixedly attached to the key blade 103. Preferably, the key bow 105 and key blade 103 are a single component. Alternatively, the key blade 103 can be affixed to the key bow 105 by, for example, a screw or snap connection.

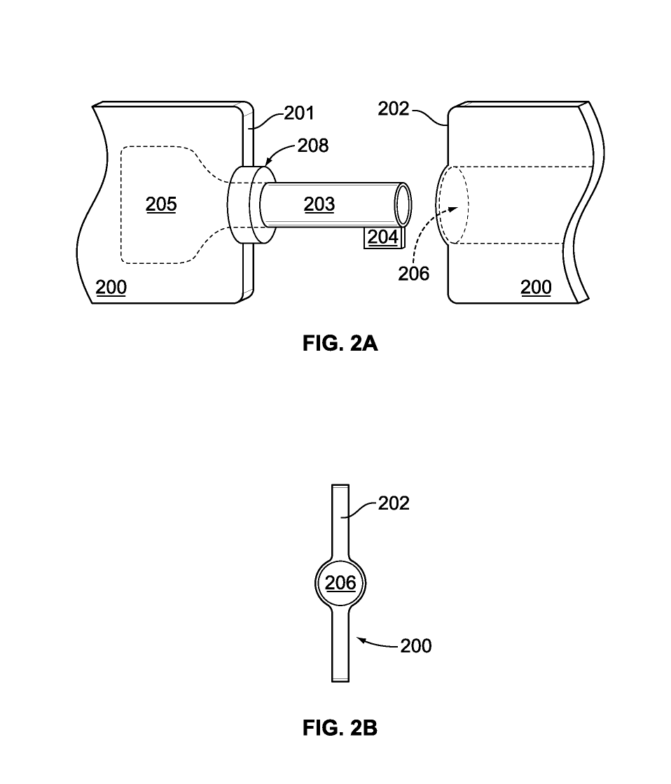

The bracelet can further include a closure mechanism. For example, the closure mechanism can be a plurality of magnets 107 positioned about the key end 101 and the receiving end 102 of the flexible bracelet body 100. These magnets 107 are, preferably, positioned to hold the key end 101 and receiving end 102 in contact with each other while the bracelet is worn by a user. Alternatively, the closure mechanism can function by a frictional gripping of the key blade 103 within the key hole 106. In one example, the key hole 106 is concentric (that is, the hole has an opening on a single face of the bracelet body) and the key blade 103 can be inserted within the key hole 106. Preferably, the key hole 106 has a diameter equal to or less than the diameter of the key blade 103 so a frictional component holds the key end 101 and receiving end 102 together when the key blade 103 is positioned within the key hole 106. Alternatively and in reference to FIGS. 2A and 2B, the key hole 206 can have a diameter approximately equal to the diameter of the key shoulder 208 so a frictional component between the key shoulder 208 and the key hole 206 can hold the key end 201 and receiving end 202 together. In another example, the key hole can be non-concentric and the key hole is exposed on a plurality of faces of the bracelet body. For illustration, the key hole can be exposed on a first face of the bracelet body that is proximal to the key end of the bracelet body (when closed), and exposed on a face perpendicular to the first face. The non-concentric key hole is adapted to provide a closure of the bracelet by positioning a length of the key blade against the key hole and pressing the length on the key blade into the key hole.

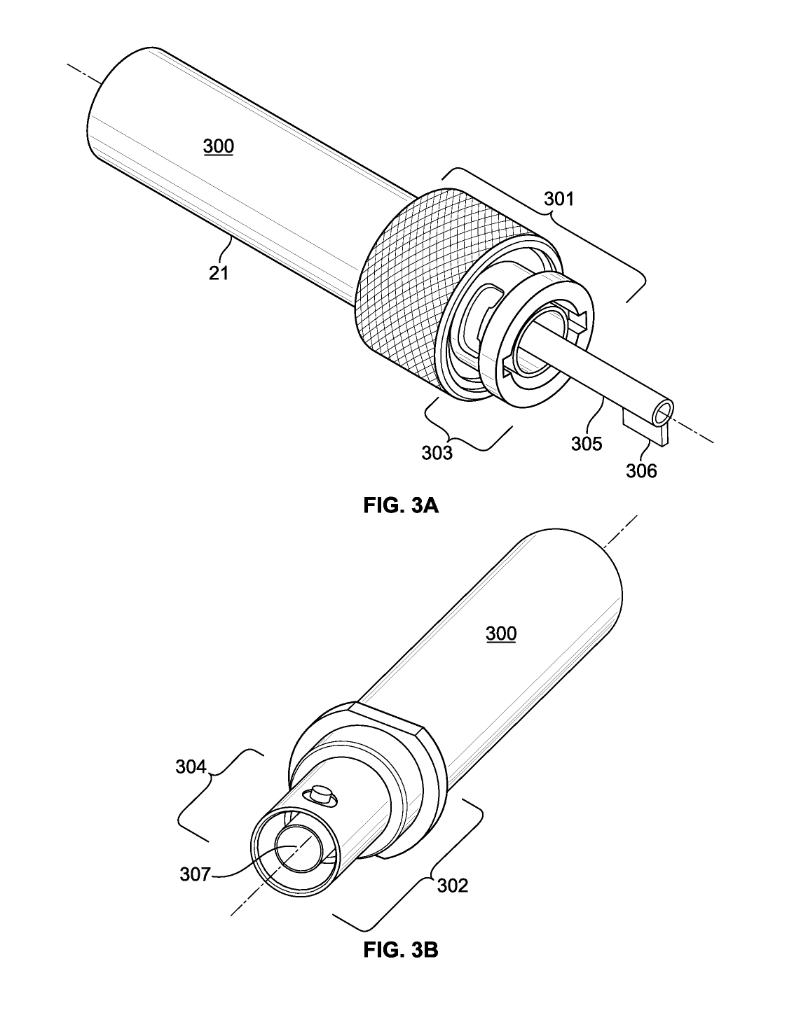

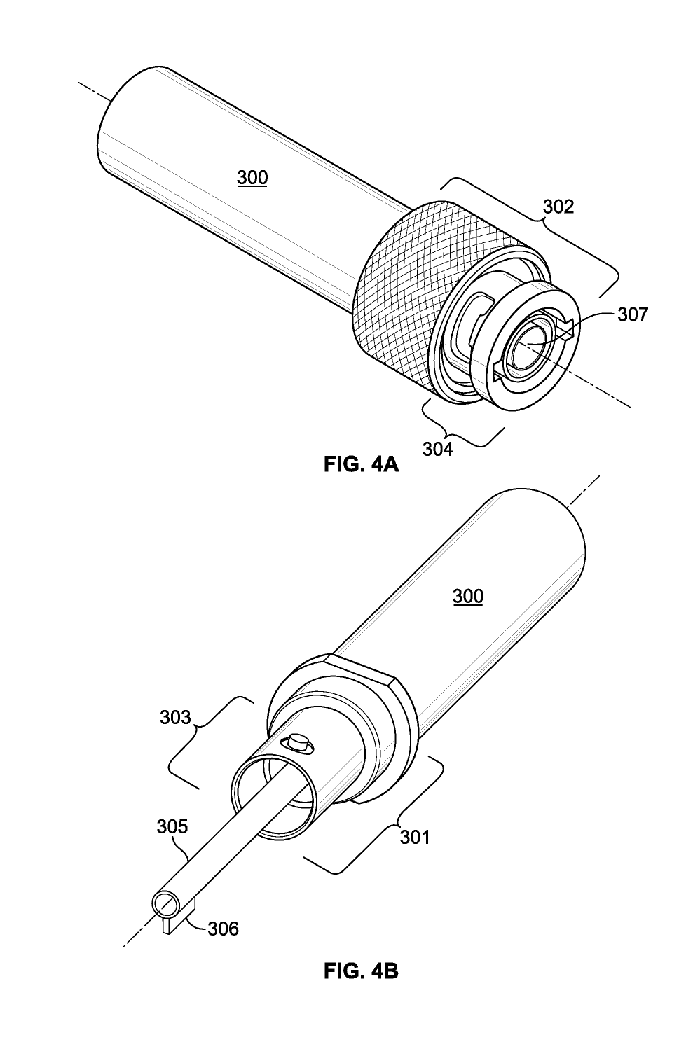

With reference to FIGS. 3 and 4: another embodiment of the herein described jewelry item includes a flexible body 300 having a key end 301 and a receiving end 302; a closure mechanism affixed to the key end 301 and receiving end 302 of the flexible body 300, the closure mechanism having a first part 303 and a second part 304 that interlock; a key blade 305 affixed to either the first part 303 or the second part 304 of the closure mechanism, the key blade 305 including a flat, rectangular bit 306 adapted to release a handcuff lock; and a receiving space 307 integral with the part of the closure mechanism that is free of the key blade 305. The closure mechanism can be selected from the group consisting of a BNC-type connector (e.g., as depicted in FIGS. 3 & 4), a RCA-type connector, a TRS-type connector, a threaded connector, a bayonet coupling, and a magnetic connector.

In one example, the jewelry item can be a bracelet or a necklace. The flexible body 300 can have a length from the key end 301 to the receiving end 302 of about 15 cm to about 75 cm. When the jewelry item is a bracelet the length is preferably about 15 cm to about 25 cm. When the jewelry item is a necklace the length is preferably about 25 cm to about 60 cm or about 35 cm to about 50 cm.

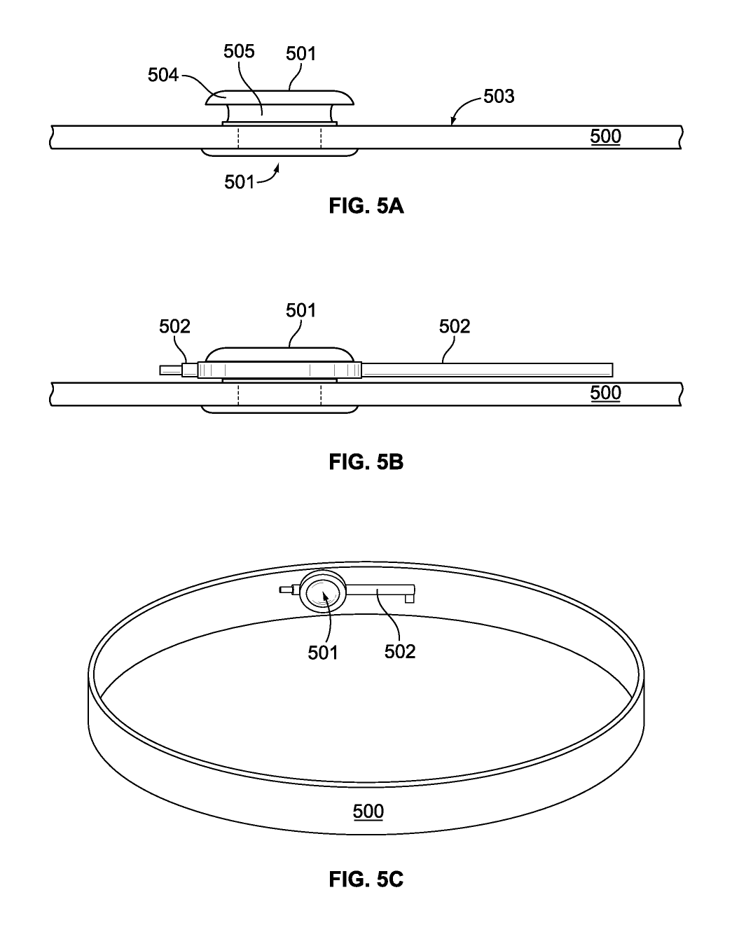

With reference to FIGS. 5: still another embodiment of the herein described jewelry item is a handcuff key bracelet that includes a flexible bracelet body 500 and a clasp 501 that is fixedly connected to the bracelet body 500 and is adapted to carry a handcuff key. In a preferable example, the clasp 501 does not close or affix two ends of the bracelet body but holds a removable or rotatable handcuff key 502. In one preferable example, the flexible bracelet body 500 is a continuous flexible band.

The clasp 501 and the flexible bracelet body 500 can be a single component. That is, the clasp 501 can be molded or formed from the flexible bracelet body. In one example, the clasp 501 can stand above a major surface 503 of the bracelet body 500. In this example, the clasp 501 can be cylindrical, standing from the major surface 503 of the bracelet body 500 and having, for example, a flat or convex surface 504. The sides 505 of the cylindrical clasp are preferably concave and adapted to secure a handcuff key 502 by fitting within a fixed, inside diameter hole in the handcuff key bow (e.g., FIG. 1, 3).

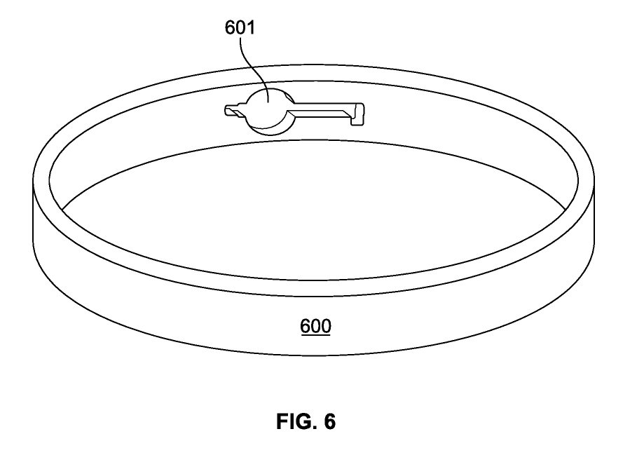

In an alternative arrangement and with reference to FIG. 6, the clasp 601 and flexible bracelet body 600 are a single component and the clasp 601 includes a cavity in the bracelet body. Preferably, the cavity has an outer edge that approximates the outer edge of a handcuff key. More preferably the cavity further includes a cylindrical element standing within the cavity and adapted to fit within a fixed, inside diameter hole in the handcuff key bow.

In another example, the clasp is a component affixed to the bracelet body. Examples of clasps can include a snap button, a magnetic snap, and a rivet. The handcuff key can be either permanently attached to the bracelet body (e.g., by a rivet) or temporarily attached to the bracelet body (e.g., by a snap button or a magnetic snap).

In one preferable example, the handcuff key can be fixedly connected to the clasp and thereby the flexible bracelet body such that the handcuff key can be removed and reconnected to the flexible bracelet body. One arrangement where the handcuff key can be removed and reconnected to the flexible bracelet body includes a two component clasp that is selected from a snap button and a magnetic snap. One component of this two component clasp is affixed to the flexible bracelet body and the other component of the clasp is affixed to the handcuff key. Accordingly, the handcuff key and the affixed clasp component can be removed and reconnected to the bracelet.

In another example, the clasp is adapted to both affix the handcuff key to the bracelet body and affix or connect two ends of the bracelet. In this example, handcuff key bracelet has a flexible bracelet body that includes a first end and a second end, and includes a two component clasp selected from a snap button and a magnetic snap. One component of the clasp is affixed to the first end of the flexible bracelet body and the other component of the clasp is affixed to the handcuff key and the second end of the flexible bracelet body. Thereby, a user can un-clasp the bracelet by disconnected the two components of the clasp and then has a handcuff key affixed to one end of the flexible bracelet body and one component of the clasp.

What is claimed:

1. A bracelet comprising:
a flexible bracelet body having a key end and a receiving end;
a key blade extending from the key end of the flexible bracelet body, the key blade including a flat, rectangular bit adapted to release a handcuff lock; and
a key hole integral with the receiving end of the flexible bracelet body.

2. The bracelet of claim 1 further comprising a key bow fixedly connected to the key end of the flexible bracelet body.

3. The bracelet of claim 1, wherein the key blade is partially hollow.

4. The bracelet of claim 1 further comprising a plurality of magnets positioned about the key end and the receiving end of the flexible bracelet body, the magnets positioned to hold the key end and receiving end in contact with each other while the bracelet is worn by a user.

5. The bracelet of claim 1, wherein the key hole has a diameter equal to or less than the diameter of the key blade so a frictional component holds the key end and receiving end together when the key blade is positioned within the key hole.

6. The bracelet of claim 1 further comprising a key shoulder integral with the key blade and proximal to the key end of the flexible bracelet body, wherein the key hole has a diameter approximately equal to the diameter of the key shoulder.

7. A jewelry item comprising:
a flexible body having a key end and a receiving end;
a closure mechanism affixed to the key end and receiving end of the flexible body, the closure mechanism having a first part and a second part that interlock;
a key blade affixed to either the first part or the second part of the closure mechanism, the key blade including a flat, rectangular bit adapted to release a handcuff lock; and
a receiving space integral with the part of the closure mechanism that is free of the key blade.

8. The jewelry item of claim 7 wherein the closure mechanism is selected from the group consisting of a BNC-type connector, a RCA-type connector, a TRS-type connector, a threaded connector, a bayonet coupling, and a magnetic connector.

9. The jewelry item of claim 7, wherein the flexible body has a length from the key end to the receiving end of about 15 cm to about 75 cm.

10. The jewelry item of claim 7, wherein the key blade is partially hollow.

11. A handcuff key bracelet comprising:
a flexible bracelet body;
a clasp fixedly connected to the bracelet body and adapted to carry a handcuff key.

12. The handcuff key bracelet of claim 11, wherein the clasp and the flexible bracelet body are a single component.

13. The handcuff key bracelet of claim 11, wherein the clasp is selected from a snap button, a magnetic snap, and a rivet.

14. The handcuff key bracelet of claim 11 further comprising a handcuff key fixedly connected to the clasp and thereby the flexible bracelet body; wherein the handcuff key can be removed and reconnected to the flexible bracelet body.

15. The handcuff key bracelet of claim 14, wherein the clasp is a two component clasp selected from a snap button and a magnetic snap, wherein one component of the clasp is affixed to the flexible bracelet body and the other component of the clasp is affixed to the handcuff key.

16. The handcuff key bracelet of claim 11, wherein the flexible bracelet body includes a first end and a second end; wherein the clasp is a two component clasp selected from a snap button and a magnetic snap, wherein one component of the clasp is affixed to the first end of the flexible bracelet body and the other component of the clasp is affixed to the handcuff key and the second end of the flexible bracelet body.

17. The handcuff key bracelet of claim 11, wherein the clasp includes a cavity, the cavity having an outer edge that approximates the outer edge of a handcuff key.
